(19) United States
(12) Patent Application Publication
(10) Pub. No.: US 2025/0358660 A1
(43) Pub. Date: Nov. 20, 2025

(54) RADIO COMMUNICATION SYSTEM, BASE STATION APPARATUS, AND COMMUNICATION QUALITY PRESENTATION METHOD

(71) Applicant: NIPPON TELEGRAPH AND TELEPHONE CORPORATION, Tokyo (JP)

(72) Inventors: Takeru FUKUSHIMA, Tokyo (JP); Motoharu SASAKI, Tokyo (JP); Toshiro NAKAHIRA, Tokyo (JP); Daisuke MURAYAMA, Tokyo (JP); Takatsune MORIYAMA, Tokyo (JP)

(21) Appl. No.: 18/873,011

(22) PCT Filed: Jun. 27, 2022
(86) PCT No.: PCT/JP2022/025629

§ 371 Date: Dec. 9, 2024

(51) Int. Cl. H04W 24/10; G06F 16/13; H04B 17/373; H04W 16/18; H04W 64/00

(52) U.S. Cl. CPC H04W 24/10; H04B 17/373; H04W 16/18; H04W 64/006; G06F 16/134

(57) ABSTRACT

A wireless communication system that performs connection control using a blockchain includes a base station apparatus and a terminal device that makes a contract for connection to the base station apparatus, in which the base station apparatus calculates a predicted value of communication quality providable to the terminal device on the basis of information obtained by measurement for the terminal device, and presents the predicted value to the terminal device.

### TECHNICAL FIELD

The present invention relates to a wireless communication system using a blockchain.

### BACKGROUND ART

A wireless communication system that performs distributed processing of connection control using a blockchain in connection control between a base station device BS and a terminal device UE is known (see, for example, Non Patent Literature 1).

It is assumed that, in a wireless communication system using a blockchain, when a terminal device UE makes a contract for performing communication with a base station device BS, providable communication quality is presented from the base station device BS to the terminal device UE.

### CITATION LIST

### Non Patent Literature

Non Patent Literature 1: X. Ling, et al., “Blockchain Radio Access Network (B-RAN): Towards Decentralized Secure Radio Access Paradigm,” IEEE ACCESS, Vol. 7, pp. 9714-9723, January 2019
Non Patent Literature 2: https://www.docomo.ne.jp/binary/pdf/corporate/technology/rd/technical_journal/bn/vol28_3/vol28_3_011jp.pdf

### SUMMARY OF INVENTION

### Technical Problem

Even in a coverage area of a single base station device BS, communication quality varies depending on a location (environment such as a large number of obstacles) in the coverage area. Furthermore, communication quality varies depending on the moving speed of a terminal device UE that moves in the coverage area. Generally, communication quality of a terminal device UE that moves at high speed is lower than communication quality of a terminal device UE that moves at low speed.

However, in a wireless communication system using a blockchain in the conventional technology, it is difficult to present communication quality suitable for a situation such as an environment and speed of a terminal device UE that newly makes a contract to the terminal device UE.

Therefore, in the conventional technology, there is a possibility that a base station device BS cannot provide communication quality agreed with a terminal device UE when a contract is made in actual communication. Furthermore, since there is a time lag related to contract authentication from agreement of connection conditions to establishment of a contract, there is a possibility that a base station device BS cannot provide communication quality agreed with a terminal device UE when a contract is made in actual communication.

The present invention has been made in view of the above points, and an object thereof is to provide a technology that enables a base station device to predict and present, to a terminal device that newly makes a contract, communication quality suitable for a situation of the terminal device in a wireless communication system using a blockchain.

### Solution to Problem

According to the disclosed technology, there is provided a wireless communication system that performs connection control using a blockchain, the wireless communication system including
a base station apparatus and a terminal device that makes a contract for connection to the base station apparatus,
in which the base station apparatus calculates a predicted value of communication quality providable to the terminal device on a basis of information obtained by measurement for the terminal device, and presents the predicted value to the terminal device.

### Advantageous Effects of Invention

According to the disclosed technology, there is a technology that enables a base station apparatus to predict and present, to a terminal device that newly makes a contract, communication quality suitable for a situation of the terminal device in a wireless communication system using a blockchain.

### BRIEF DESCRIPTION OF DRAWINGS

FIG. 1 is a diagram for describing an outline of processing of a wireless communication system using a blockchain.

FIG. 2 is a diagram illustrating an example of a system configuration of a wireless communication system 100.

FIG. 3 is a diagram illustrating a blockchain network BN.

FIG. 4 is a diagram for illustrating an outline of a first embodiment.

FIG. 5 is a configuration diagram of a base station device BS.

FIG. 6 is a configuration diagram of a terminal device UE.

FIG. 7 is a flowchart in the first embodiment.

FIG. 8 is a diagram for describing operation in the first embodiment.

FIG. 9 is a diagram for describing operation in the first embodiment.

FIG. 10 is a diagram for describing operation in the first embodiment.

FIG. 11 is a diagram for illustrating an outline of a second embodiment.

FIG. 12 is a flowchart in the second embodiment.

FIG. 13 is a diagram for describing operation in the second embodiment.

FIG. 14 is a diagram for describing operation in the second embodiment.

FIG. 15 is a diagram for describing operation in the second embodiment.

FIG. 16 is a diagram illustrating an example hardware configuration of a device.

### DESCRIPTION OF EMBODIMENTS

Embodiments of the present invention (present embodiments) will be described below with reference to the drawings. Each of the embodiments described below is merely an example, and embodiments to which the present invention is applied are not limited to the following embodiments.

### (Wireless Communication System Using Blockchain)

Since the present embodiments are based on a wireless communication system using a blockchain, first, basic processing content in the wireless communication system using a blockchain will be described. The present wireless communication system is a system that can connect a terminal device UE to a base station device BS without centralized management by performing connection processing in a distributed manner using a blockchain technology at the time of connection processing between the base station device BS and the terminal device UE.

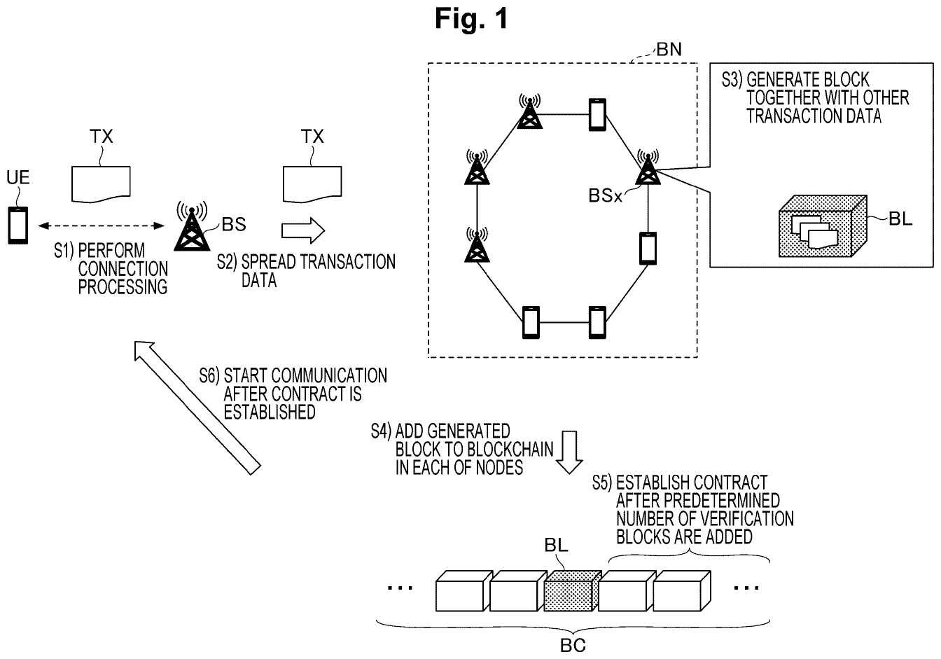

FIG. 1 is a diagram for describing an outline of processing of a wireless communication system using a blockchain. In the wireless communication system, transaction data 2 is created between the base station device BS and the terminal device UE in connection processing in which the terminal device UE is connected to the base station device BS (S1).

For example, the terminal device UE receives connection conditions transmitted by the base station device BS, and checks the communication quality, the connection cost, and the like of a wireless communication network provided by a wireless base station 10. On the other hand, the base station device BS checks whether the terminal device UE has sufficient payment capability. Furthermore, in a case where an agreement on the connection conditions is obtained between the base station device BS and the terminal device UE, the base station device BS records the agreement content in the transaction data 2.

Note that the communication quality of the wireless communication network provided by the base station device BS includes, for example, throughput, a total data amount, or the like. The terminal device UE may agree to the connection conditions in a case where the communication quality provided by the base station device BS satisfies all the communication quality requested by the terminal device UE. Alternatively, the terminal device UE may agree to the connection conditions in a case where the communication quality provided by the base station device BS satisfies a part of the communication quality requested by the terminal device UE.

The base station device BS spreads the transaction data TX created in the connection processing to nodes participating in the blockchain network BN (S2). The blockchain network BN includes a plurality of nodes sharing a blockchain (distributed ledger) in which the transaction data TX is collectively recorded in units of blocks and a plurality of blocks is recorded in time series. The plurality of nodes includes a plurality of base station devices BS included in the wireless communication system. Note that the plurality of nodes may include a node (computer, terminal device, or the like) other than a base station device BS.

In the blockchain network BN, when notice of the transaction data TX is given, some nodes participating in the blockchain network BN (for example, base station device 10×) generate a block BL together with other transaction data (S3). Furthermore, after the block BL is generated, the blockchain network BN adds the generated block BL to a blockchain BC included in each of the nodes included in the blockchain network BN (S4).

A contract is established by the blockchain BC of each of the nodes holding the added block BL, a predetermined number of blocks (verification blocks) being further added to the blockchain BL, and then the held block being accepted (S5). After the contract is established, the base station device BS starts communication with the terminal device UE (S6).

With the above processing, the wireless communication system can execute connection processing between the base station device BS and the terminal device UE by distributed control without depending on a control station or the like that performs centralized control on the wireless communication system.

### (System Configuration)

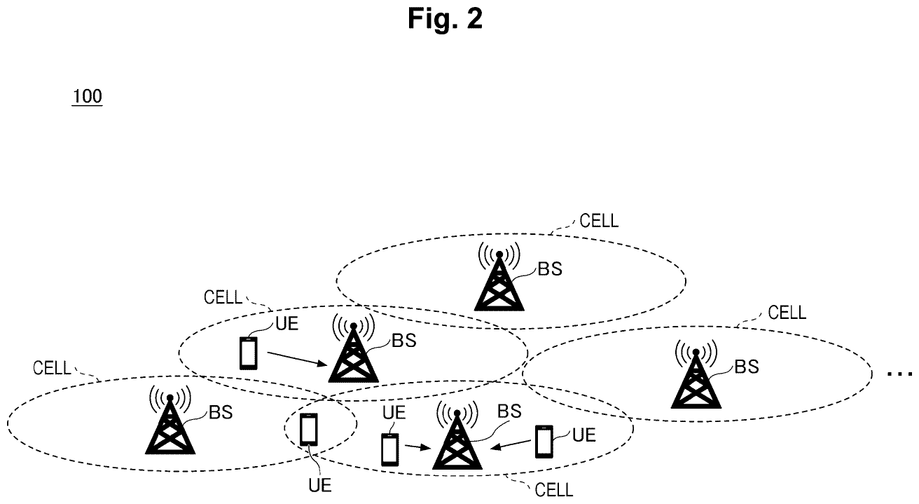

FIG. 2 is a diagram illustrating an example of a system configuration of a wireless communication system 100 according to the present embodiment. As illustrated in FIG. 2, the wireless communication system 100 includes a plurality of base station devices BS that forms different cells. Each of the base station devices BS can communicate with a terminal device UE in the cell.

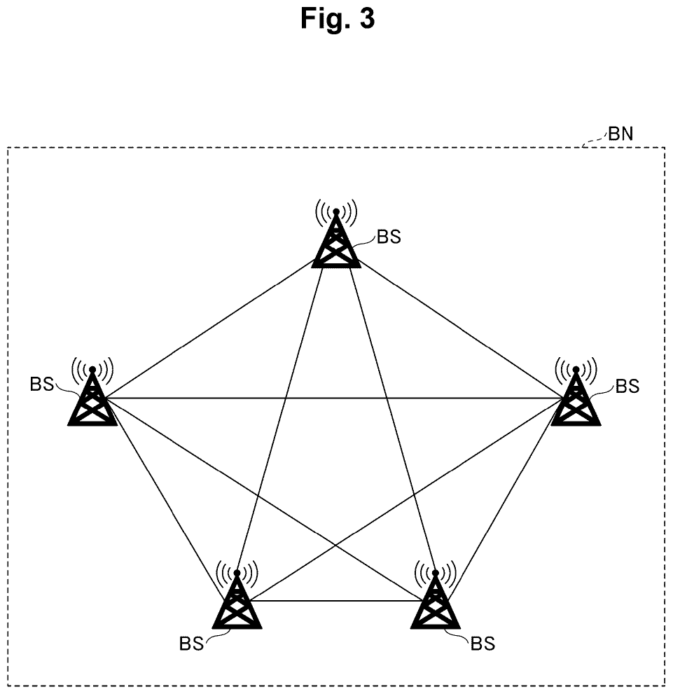

Further, as illustrated in FIG. 3, for example, the plurality of base station devices BS also functions as nodes participating in the blockchain network BN, and the plurality of base station devices BS shares the same blockchain. Here, the blockchain network BN is a peer-to-peer (P2P) network (distributed network) in which each of the nodes can transmit and receive data to and from other nodes on an equal footing without a server or the like. The blockchain is an example of a distributed ledger in which a plurality of nodes participating in a P2P network records a transaction or the like between two parties in a verifiable and permanent manner.

Note that the blockchain network BN may include a node (for example, another computer, terminal device, or the like) other than a base station device BS. Furthermore, the base station device BS may request a node participating in the blockchain network BN to, for example, acquire and record ledger information without holding a blockchain.

Each of the base station devices BS manages connection with a terminal device UE using a blockchain. For example, each of the base station devices BS records and manages contract information such as the transaction data TX described in FIG. 1 in a blockchain shared by a plurality of base station devices BS. As a result, a base station device BS can acquire information of another base station device BS (for example, connection cost of another base station device 110, number of terminal devices 120 connected to another base station device 110, or the like) with reference to the blockchain.

### (Issues)

As described above, in the wireless communication system in the present embodiments, it is assumed that when the terminal device UE makes a communication contract, a base station device BS presents providable communication quality to the terminal device UE. Under this assumption, there are the following Issues 1 and 2.

### Issue 1:

Even in a coverage area of a single base station device BS, a propagation environment varies depending on a location in the coverage area, and communication quality varies. Therefore, there is a possibility that a base station device BS cannot present appropriate providable communication quality to a terminal device UE that newly makes a contract.

### Issue 2:

Even in a coverage area of a single base station device BS, when the moving speed (moving velocity) of a terminal device UE increases, there is a possibility that fading, Doppler shift, and the like during communication increase, a signal waveform is deformed, and communication quality deteriorates. That is, the communication quality varies depending on the moving speed of the terminal device UE. Therefore, there is a possibility that a base station device BS cannot present appropriate providable communication quality to a terminal device UE that newly makes a contract.

Hereinafter, a first embodiment corresponding to a technology for solving Issue 1 and a second embodiment corresponding to a technology for solving Issue 2 will be described. The first embodiment and the second embodiment can be implemented in combination.

### First Embodiment

First, the first embodiment will be described.

### (Outline of Processing)

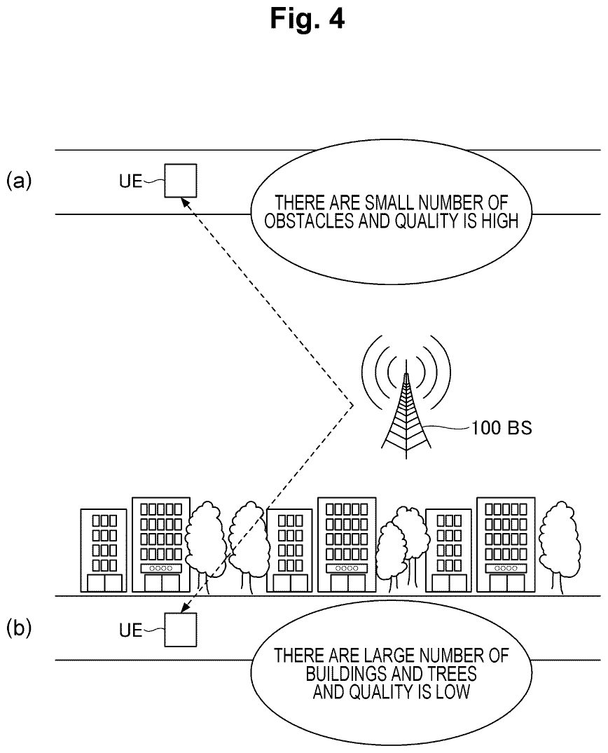

An outline of processing for solving above-described Issue 1 in the wireless communication system of the present embodiment will be described with reference to FIG. 4.

As described above, the propagation environment varies even in a coverage area of a single base station device BS since the amount of obstacles such as buildings and trees varies depending on the area (location) in the coverage area, and the communication quality varies.

FIG. 4 illustrates a case in which a terminal device UE exists in an area with a small number of obstacles and high communication quality ((a) of FIG. 4) and a case in which a terminal device UE exists in an area with a large number of obstacles and low communication quality ((b) of FIG. 4). Here, it is assumed that a new contract is made between a base station device BS 100 and a terminal device UE.

The base station device BS 100 acquires the position of the terminal device UE that newly makes a contract by measurement such as beamforming or wireless sensing.

Next, the base station device BS 100 extracts actual values of communication quality for another terminal device UE that has made a contract in the past at a position close to the terminal device UE that newly makes a contract from its own station log or the like, and uses an average value or the like of the extracted actual values as a predicted value of communication quality providable to the terminal device UE that newly makes a contract. The use of the average value of the actual values as the predicted value of the providable communication quality is an example, and a value other than the average value may be used.

As described above, a value in which variation in communication quality is taken into consideration can be presented to the terminal device UE that newly makes a contract by the position of the terminal device UE that newly makes a contract being grasped and actual values of communication quality of another terminal device UE that has made a contract at a close position in the past.

### (Device Configuration Example)

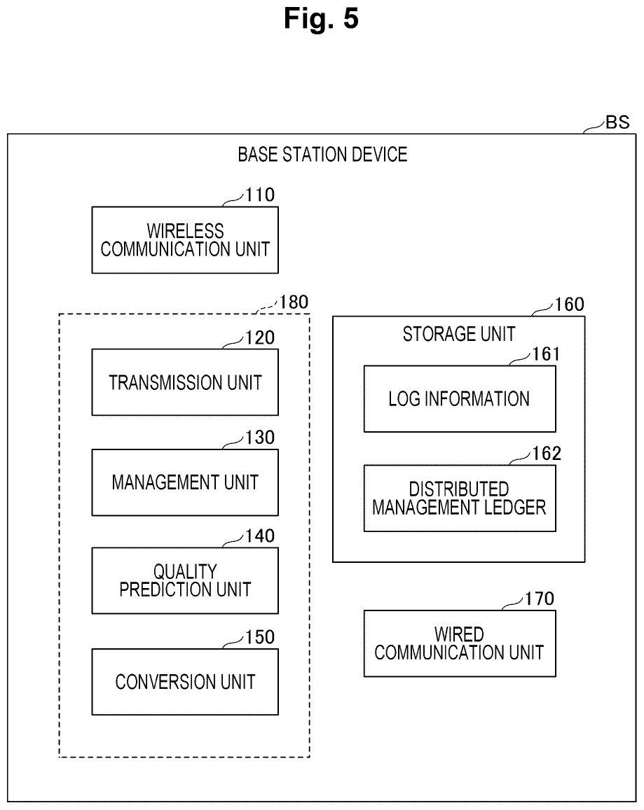

FIG. 5 illustrates a configuration example of a base station device BS. The base station device BS includes, for example, a configuration of a computer, and the computer executes a predetermined program to implement a wireless communication unit 110, a transmission unit 120, a management unit 130, a quality prediction unit 140, a conversion unit 150, a storage unit 160, a wired communication unit 170, and the like. At least some of functional configurations described above may be implemented by hardware. The management unit 130 and the quality prediction unit 140 may be collectively referred to as a “quality prediction unit”.

The wireless communication unit 110 forms a cell capable of performing wireless communication with the base station device BS, and executes wireless communication processing of performing wireless communication with a terminal device UE connected to the base station device BS.

The transmission unit 120 executes transmission processing of transmitting connection conditions for connection to the base station device BS to a terminal device UE in the cell of the base station device BS. The connection conditions include, for example, information such as the communication quality to be provided and the connection cost (connection fee) for connection to the base station device BS. Note that, in the present embodiment, attention is particularly focused on communication quality as the connection conditions.

The management unit 130 executes management processing of managing information of a terminal device UE connected to the base station device BS on the basis of the connection conditions transmitted by the transmission unit 120 using a blockchain shared by a plurality of base station devices BS. For example, the management unit 130 records connection information with a terminal device UE requesting connection to the base station device BS in a distributed management ledger 162 (which may be referred to as a blockchain) shared with other base station devices BS by executing a series of processing described in S1 to S6 of FIG. 1 with the terminal device UE. As information regarding a terminal device UE that has made a communication contract, any one, a plurality, or all of “position, moving speed, and moving direction” of the terminal device UE at the time of making a contract may be recorded in the distributed management ledger 162.

Furthermore, the management unit 130 executes various types of processing of managing a blockchain as a node of the blockchain shared by a plurality of base station devices BS. By similar processing being executed also in other base station devices BS, information of a terminal device UE connected to each of the base station devices BS in the wireless communication system 100 is recorded in the distributed management ledger 162. Therefore, the base station device BS can acquire information of terminal devices UE connected to the other base station devices BS by referring to the distributed management ledger 162.

The operation of the quality prediction unit 140 will be described below. The conversion unit 150 executes change processing of changing connection conditions of the base station device BS (own station) on the basis of the information of the terminal devices UE connected to the other base station devices BS.

Note that the transmission unit 120, the management unit 130, the quality prediction unit 140, the conversion unit 150, and the like are included in, for example, a communication control unit 180 that controls wireless communication by the wireless communication unit 110.

The storage unit 160 executes storage processing of storing various types of data, information, programs, and the like including log information 161 and the distributed management ledger 162 in a storage device or the like included in the wireless base station BS, for example. The log information 161 includes actual values of communication quality with each UE, a communication parameter of each UE, and the like in the base station device BS (own station). Furthermore, the log information 161 may additionally include actual values of communication quality with each UE, a communication parameter of each UE, and the like in the other base station devices BS.

The wired communication unit 170 connects the base station device BS to, for example, a wired communication network, and executes communication related to the blockchain network BN as illustrated in FIG. 3.

### (Functional Configuration of Terminal Device UE)

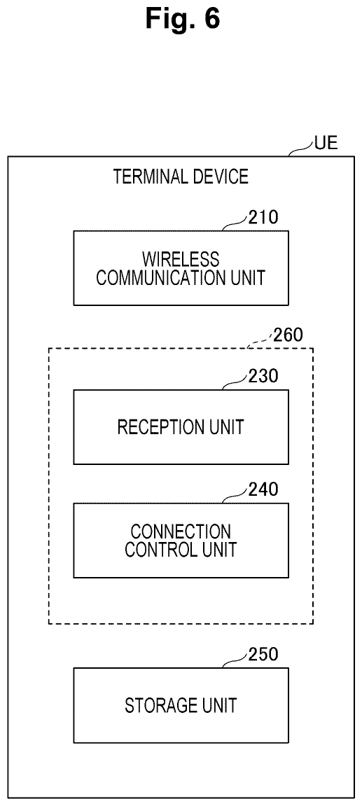

FIG. 6 is a diagram illustrating an example of a functional configuration of a terminal device UE according to the present embodiment. The terminal device UE includes, for example, a configuration of a computer, and the computer executes a predetermined program to implement a wireless communication unit 210, a reception unit 230, a connection control unit 240, a storage unit 250, and the like. At least some of functional configurations described above may be implemented by hardware.

The wireless communication unit 210 is connected to a base station device BS by wireless communication and executes wireless communication processing of transmitting and receiving data. The reception unit 230 executes reception processing of receiving connection conditions transmitted by a base station device BS using the wireless communication unit 210.

The connection control unit 240 executes connection processing of making connection to a base station device BS. For example, in the connection processing described in step S1 of FIG. 1, the connection control unit 240 transmits a connection request to a base station device BS, and, for example, concludes an agreement regarding a wireless communication service to be provided.

Note that the reception unit 230, the connection control unit 240, and the like are included in, for example, a communication control unit 260 that controls wireless communication by the wireless communication unit 210.

The storage unit 250 executes storage processing of storing various types of data, information, programs, and the like necessary for wireless communication in a storage device or the like included in the terminal device UE, for example.

### (Flow of Processing)

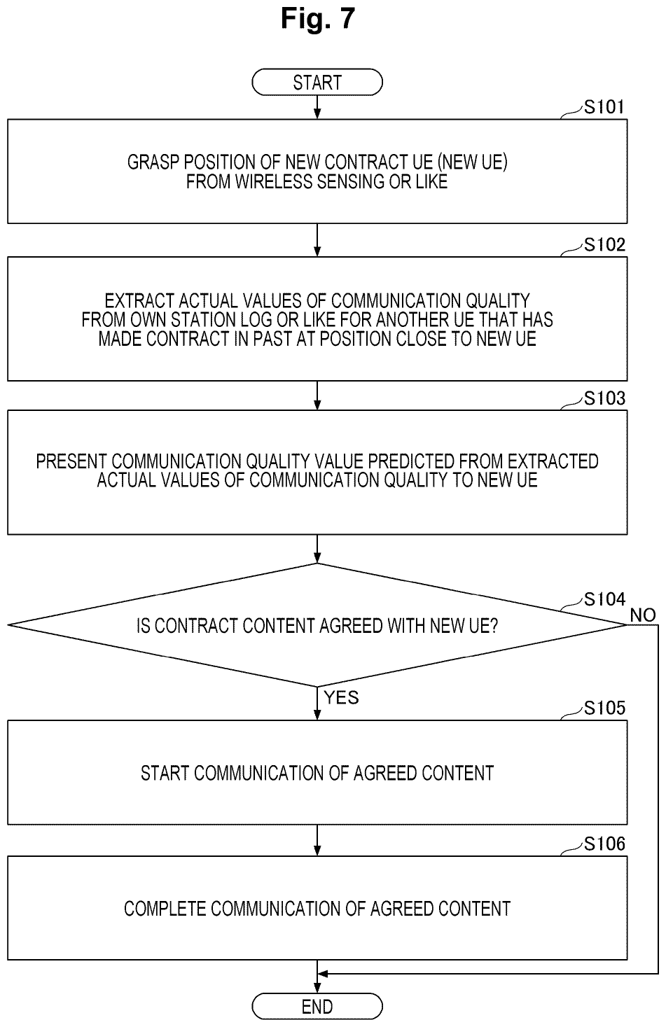

Next, with reference to the flowchart of FIG. 7, processing by a base station device BS having the configuration of FIG. 5 until communication with a terminal device UE that newly makes a contract is started will be described. Note that the terminal device UE that newly makes a contract is referred to as “new contract UE or “new UE”. Here, it is assumed that the base station device BS has already received a connection request including the ID of the new contract UE from the new contract UE.

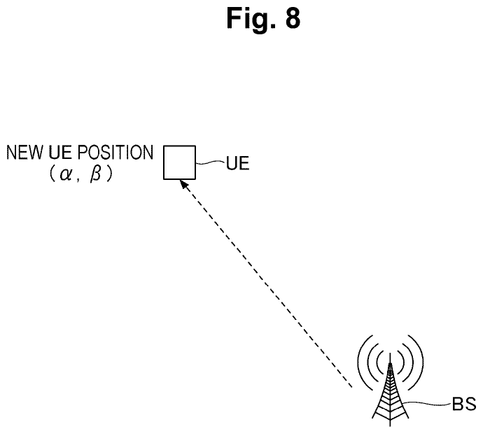

In S101, the quality prediction unit 140 acquires the position of the new contract UE (new UE) from wireless sensing or the like. FIG. 8 illustrates an image of acquiring the position of the new contract UE. Furthermore, the quality prediction unit 140 may acquire the moving direction of the new contract UE together with the position of the new contract UE.

Note that any method may be used as a method of acquiring the position and the moving direction. For example, arrival angle estimation may be performed using beamforming, or the position of the new contract UE may be grasped by applying a position estimation technology using channel state information (CSI) or the like.

In S102, the quality prediction unit 140 extracts actual values of communication quality from the own station log or the like (example: log information 161) for another UE that has made a contract in the past at a position close to the new contract UE. The another UE that has made a contract in the past at a position close to the new contract UE means that a position of the another UE that has made a contract in the past at the time of making the contract is close to the position of the new contract UE. The another UE that has made a contract in the past at a position close to the new contract UE may mean that a position of the another UE that has made a contract in the past immediately before the contract is made is close to the position of the new contract UE.

More specifically, for example, the management unit 130 acquires the ID of the another UE that has made a contract in the past at a position close to the new contract UE from, for example, the distributed management ledger 162. Then, the quality prediction unit 140 acquires actual values of communication quality of the another UE in the base station device BS (own station) by searching the log information 161 with the ID of the another UE.

The “close position” means that, for example, a distance between the position of the new contract UE (position measured in S101) and the position of the another UE (position at the time of making a contract acquired from the distributed management ledger) is equal to or less than a predetermined threshold.

In a case where the moving direction is used together with the position, the quality prediction unit 140 extracts actual values of communication quality from the own station log or the like (example: log information 161) for the another UE that has made a contract in the past when moving in the moving direction close to the new contract UE at a position close to the new contract UE.

The “close moving direction” means that, for example, an absolute value of a difference between the moving direction of the new contract UE (moving direction measured in S101) and the moving direction of the another UE (moving direction at the time of making a contract acquired from the distributed management ledger) is equal to or less than a predetermined threshold. Note that the moving direction of the another UE may be estimated from transition of the most recent contract base station at the time of making a contract with the another UE. The moving direction obtained by such estimation is also included in a “moving direction at the time of making a contract acquired from the distributed management ledger”.

In S103, the quality prediction unit 140 predicts a value of communication quality of the new contract UE from the extracted actual values of the communication quality. For example, the quality prediction unit 140 sets the average value of actual values of communication quality in the base station device BS (own station) in a plurality of other UEs that have made contracts in the past at positions close to the new contract UE as a predicted value of communication quality providable to the new UE. Alternatively, the quality prediction unit 140 sets the average value of actual values of communication quality in the base station device BS (own station) at a plurality of times in another UE that has made a contract in the past at a position close to the new contract UE as a predicted value of communication quality of the new UE.

Note that the method of calculating the predicted value is not limited to the above method, and the prediction value may be calculated by any method.

Thereafter, the transmission unit 120 presents the communication quality value predicted by the quality prediction unit 140 to the new contract UE. In a case where the base station device BS agrees with the new contract UE with the communication quality value presented to the new contract UE in S104, the base station device BS starts communication of the agreed content in S105, and the communication of the agreed content is completed in S106.

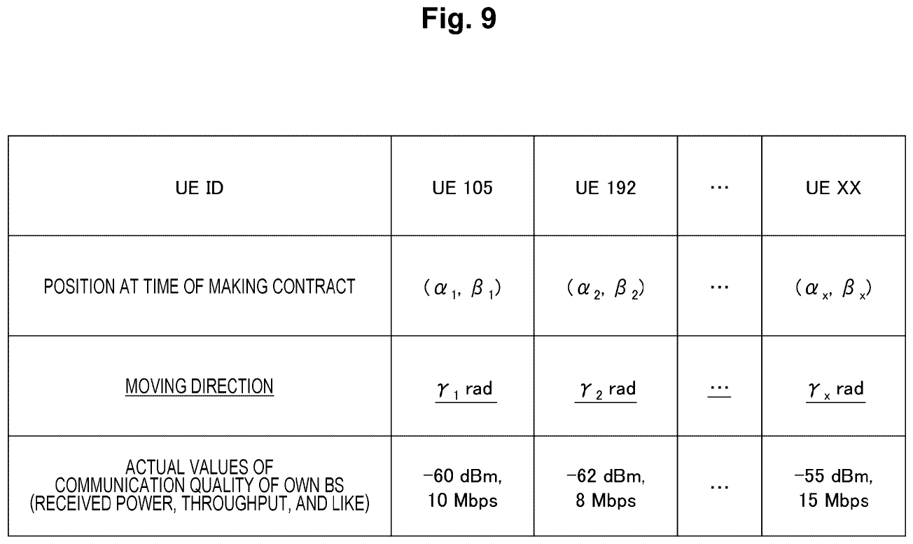

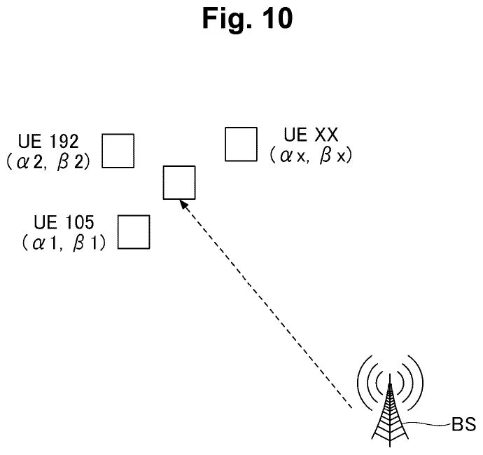

A specific example of processing of S102 to S103 will be described with reference to FIG. 9. In the example of FIG. 9, UE 105, UE 192, . . . , and UE XX are extracted as actual values of communication quality for other UEs that have made contracts in the past when moving in the moving direction close to the new contract UE at positions close to the new contract UE. Note that the positions may be expressed by a method other than (x, y). FIG. 10 illustrates each of the UEs.

The management unit 130 (or quality prediction unit 140) extracts actual values (example: received power, throughput) of communication quality with the base station device BS (own BS) from the log information 161, and the quality prediction unit 140 predicts a communication quality value providable to the new contract UE using these actual values.

Although FIG. 9 illustrates received power and throughput as the actual values, the actual log information 162 includes a large number of values during a communication time in addition to these values.

The management unit 130 may acquire communication parameters such as “multiple-input multiple-output (MIMO) numbers, numbers of antennas, bandwidths” of other UEs and the numbers of UEs accommodated in the own BSs (congestion degrees) during communication of the other UEs in the own BSs in addition to actual values of communication quality of the other UEs, and the quality prediction unit 140 may estimate communication quality providable to the new contract UE on the basis of at least one of “MIMO numbers, numbers of antennas, bandwidths, or numbers of UEs accommodated during communication (congestion degrees)” in addition to the actual values of the communication quality.

Note that the MIMO numbers may be referred to as the numbers of layers, the numbers of MIMO layers, or the like. Information such as “MIMO numbers, numbers of antennas, bandwidths, numbers of UEs accommodated during communication (congestion degrees)” may be acquired from the distributed management ledger 162 or may be acquired from the log information 161. For example, in a case where the number of antennas of a UE is included in conditions at the time of making a contract, it is assumed that the number of antennas of a UE is included in the distributed management ledger 162.

For example, in a case where the number of antennas (example of a communication parameter) of certain another UE that has made a contract in the past at a position close to the new contract UE is twice the number of antennas of the new contract UE, the quality prediction unit 140 estimates that communication quality ½ times (example: throughput of ½ times) that of the another UE is providable to the new contract UE.

### Summary of First Embodiment

As described above, in the first embodiment, even in a coverage area of a certain base station device BS, communication quality may vary depending on the location in the coverage area, and thus the communication quality that varies depending on the location can be predicted using a UE position at the time of making a contract.

Furthermore, in prediction of communication quality, by a position of a new contract UE at the time of making a contract being extracted, communication quality providable to the new contract UE is predicted on the basis of actual values of communication quality of another UE that has made a contract at a close position in the past.

### Second Embodiment

Next, the second embodiment will be described.

### (Outline of Processing)

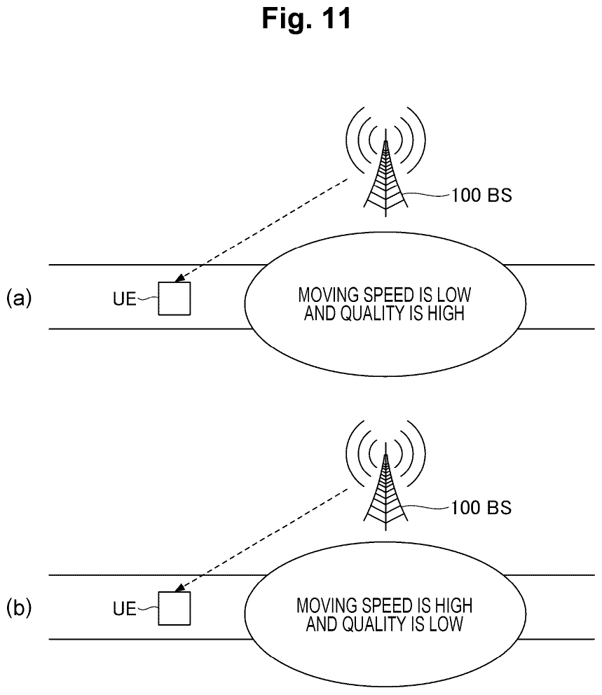

An outline of processing for solving above-described Issue 2 in the wireless communication system of the present embodiment will be described with reference to FIG. 11.

As described above, even in a coverage area of a single base station device BS, communication quality providable by the base station device BS to a terminal device UE varies depending on the moving speed of the terminal device UE.

FIG. 11 illustrates a case in which a terminal device UE moves at low speed ((a) of FIG. 11) and a case in which a terminal device UE moves at high speed ((b) of FIG. 11). In both cases of (a) and (b), it is assumed that the terminal device UE makes a contract with a base station device BS 100.

The base station device BS 100 acquires the moving speed of the terminal device UE that newly makes a contract by measurement such as wireless sensing.

Next, the base station device BS 100 extracts actual values of communication quality for another terminal device UE that has made a contract in the past at moving speed (moving velocity) close to the terminal device UE that newly makes a contract from its own station log or the like, and uses an average value or the like of the extracted actual values as a predicted value of communication quality providable to the terminal device UE that newly makes a contract. The use of the average value of the actual values as the predicted value of the providable communication quality is an example, and a value other than the average value may be used.

As described above, a value in which variation in communication quality is taken into consideration can be presented to the terminal device UE that newly makes a contract by the moving speed of the terminal device UE that newly makes a contract being grasped and actual values of communication quality of another terminal device UE that has made a contract at close moving speed in the past.

A device configuration in the second embodiment is the same as the device configuration in the first embodiment, a base station device BS has the configuration illustrated in FIG. 5, and a terminal device UE has the configuration illustrated in FIG. 6.

### (Flow of Processing)

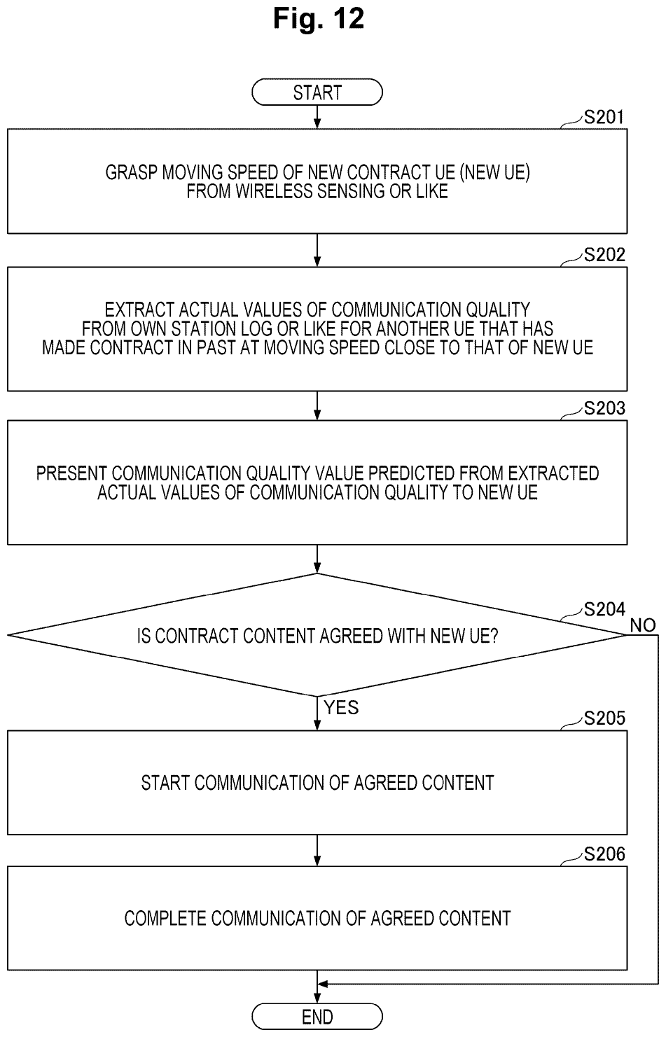

Next, with reference to the flowchart of FIG. 12, processing by a base station device BS having the configuration of FIG. 5 until communication with a terminal device UE that newly makes a contract is started will be described. Note that the terminal device UE that newly makes a contract is referred to as “new contract UE or “new UE”. Here, it is assumed that the base station device BS has already received a connection request including the ID of the new contract UE from the new contract UE.

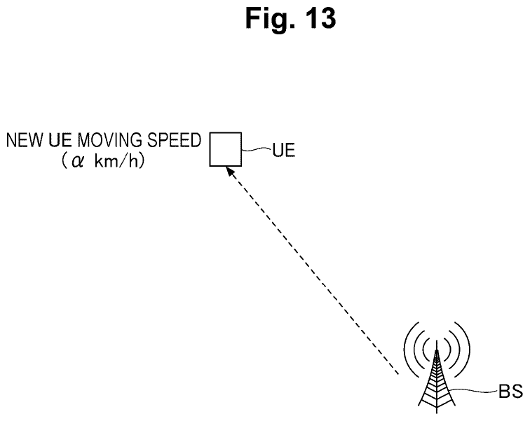

In S201, the quality prediction unit 140 acquires the moving speed of the new contract UE (new UE) from wireless sensing or the like. FIG. 13 illustrates an image of acquiring the moving speed of the new contract UE. Furthermore, the quality prediction unit 140 may acquire the moving direction of the new contract UE together with the moving speed of the new contract UE.

Note that any method may be used as a method of acquiring the moving speed and the moving direction. For example, the moving speed and the moving direction can be acquired by wireless sensing using a phase Doppler shift or a moving speed estimation technology using GPS position information or the like being applied. Note that wireless sensing is suitable for grasping speed when a UE linearly approaches (or moves away from) a BS by movement on a road or the like.

In S202, the quality prediction unit 140 extracts actual values of communication quality from the own station log or the like (example: log information 161) for another UE that has made a contract in the past at moving speed close to that of the new contract UE. The another UE that has made a contract in the past at moving speed close to that of the new contract UE means that moving speed of the another UE that has made a contract in the past at the time of making the contract is close to the moving speed of the new contract UE. The another UE that has made a contract in the past at moving speed close to that of the new contract UE may mean that moving speed of the another UE that has made a contract in the past immediately before the contract is made is close to the moving speed of the new contract UE.

More specifically, for example, the management unit 130 acquires the ID of the another UE that has made a contract in the past at moving speed close to that of the new contract UE from, for example, the distributed management ledger 162. Then, the quality prediction unit 140 acquires actual values of communication quality of the another UE in the base station device BS (own station) by searching the log information 161 with the ID of the another UE.

The “close moving speed” means that, for example, an absolute value of a difference between the moving speed of the new contract UE (moving speed measured in S201) and the moving speed of the another UE (moving speed at the time of making a contract acquired from the distributed management ledger) is equal to or less than a predetermined threshold. Note that the moving speed of the another UE may be estimated from transition of the most recent contract base station at the time of making a contract with the another UE. The moving direction obtained by such estimation is also included in “moving speed at the time of making a contract acquired from the distributed management ledger”.

In a case where the moving direction is used together with the moving speed, the quality prediction unit 140 extracts actual values of communication quality from the own station log or the like (example: log information 161) for the another UE that has made a contract in the past when moving in the moving direction close to the new contract UE at moving speed close to that of the new contract UE.

The “close moving direction” means that, for example, an absolute value of a difference between the moving direction of the new contract UE (moving direction measured in S201) and the moving direction of the another UE (moving direction at the time of making a contract acquired from the distributed management ledger) is equal to or less than a predetermined threshold. Note that the moving direction of the another UE may be estimated from transition of the most recent contract base station at the time of making a contract with the another UE. The moving direction obtained by such estimation is also included in a “moving direction at the time of making a contract acquired from the distributed management ledger”.

In S203, the quality prediction unit 140 predicts a value of communication quality of the new contract UE from the extracted actual values of the communication quality. For example, the quality prediction unit 140 sets the average value of actual values of communication quality in the base station device BS (own station) in a plurality of other UEs that have made contracts in the past at moving speed close to that of the new contract UE as a predicted value of communication quality providable to the new UE. Alternatively, the quality prediction unit 140 sets the average value of actual values of communication quality in the base station device BS (own station) at a plurality of times in another UE that has made a contract in the past at moving speed close to that of the new contract UE as a predicted value of communication quality of the new UE.

Note that the method of calculating the predicted value is not limited to the above method, and the prediction value may be calculated by any method.

Thereafter, the transmission unit 120 presents the communication quality value predicted by the quality prediction unit 140 to the new contract UE. In a case where the base station device BS agrees with the new contract UE with the communication quality value presented to the new contract UE in S204, the base station device BS starts communication of the agreed content in S205, and the communication of the agreed content is completed in S206.

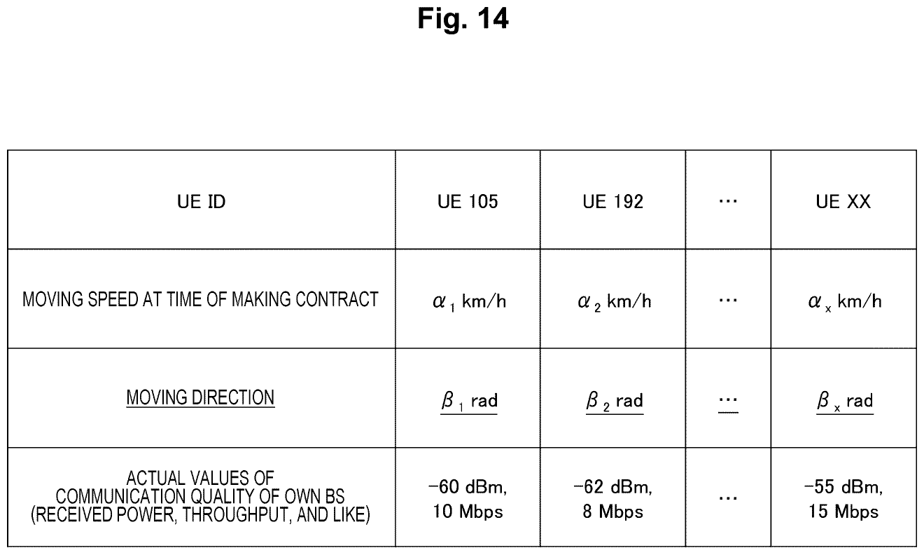

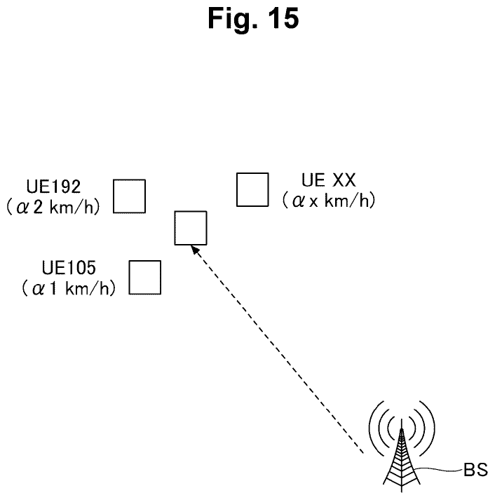

A specific example of processing of S202 to S203 will be described with reference to FIG. 14. In the example of FIG. 14, UE 105, UE 192, . . . , and UE XX are extracted as actual values of communication quality for other UEs that have made contracts in the past when moving in the moving direction close to the new contract UE at moving speed close to that of the new contract UE. FIG. 15 illustrates each of the UEs.

The management unit 130 (or quality prediction unit 140) extracts actual values (example: received power, throughput) of communication quality with the base station device BS (own BS) from the log information 161, and the quality prediction unit 140 predicts a communication quality value providable to the new contract UE using these actual values.

Although FIG. 14 illustrates received power and throughput as the actual values, the actual log information 162 includes a large number of values during a communication time in addition to these values.

The management unit 130 may acquire communication parameters such as “multiple-input multiple-output (MIMO) numbers, numbers of antennas, bandwidths” of other UEs and the numbers of UEs accommodated in the own BSs (congestion degrees) during communication of the other UEs in the own BSs in addition to actual values of communication quality of the other UEs, and the quality prediction unit 140 may estimate communication quality providable to the new contract UE on the basis of at least one of “MIMO numbers, numbers of antennas, bandwidths, or numbers of UEs accommodated during communication (congestion degrees)” in addition to the actual values of the communication quality.

Note that the MIMO numbers may be referred to as the numbers of layers, the numbers of MIMO layers, or the like. Information such as “MIMO numbers, numbers of antennas, bandwidths, numbers of UEs accommodated during communication (congestion degrees)” may be acquired from the distributed management ledger 162 or may be acquired from the log information 161. For example, in a case where the number of antennas of a UE is included in conditions at the time of making a contract, it is assumed that the number of antennas of a UE is included in the distributed management ledger 162.

For example, in a case where the number of antennas (example of a communication parameter) of certain another UE that has made a contract in the past at moving speed close to that of the new contract UE is twice the number of antennas of the new contract UE, the quality prediction unit 140 estimates that communication quality ½ times (example: throughput of ½ times) that of the another UE is providable to the new contract UE.

### Summary of Second Embodiment

As described above, in the second embodiment, even in a coverage area of a certain base station device BS, communication quality may vary depending on the moving speed of a terminal device UE in the coverage area, and thus the communication quality that varies can be predicted using moving speed of a UE at the time of making a contract.

Furthermore, in prediction of communication quality, by moving speed of a new contract UE at the time of making a contract being grasped, communication quality providable to the new contract UE is predicted on the basis of actual values of communication quality of another UE that has made a contract at moving speed close to the moving speed in the past.

Note that, in both the first embodiment and the second embodiment, prediction of communication quality providable to a terminal device UE may be performed on the basis of information regarding both a current position and moving speed of the terminal device UE.

### (Hardware Configuration Example)

Any device (base station device BS, terminal device UE) described in the first and second embodiments can be implemented by causing a computer to execute a program, for example. This computer may be a physical computer, or may be a virtual machine on a cloud.

That is, the device can be implemented by a program corresponding to processing performed by the device being executed by use of a hardware resource such as a central processing unit (CPU) and a memory built in the computer. The above program can be stored and distributed by being recorded in a computer-readable recording medium (portable memory or the like). Furthermore, the program can also be provided via a network such as the Internet or an electronic mail.

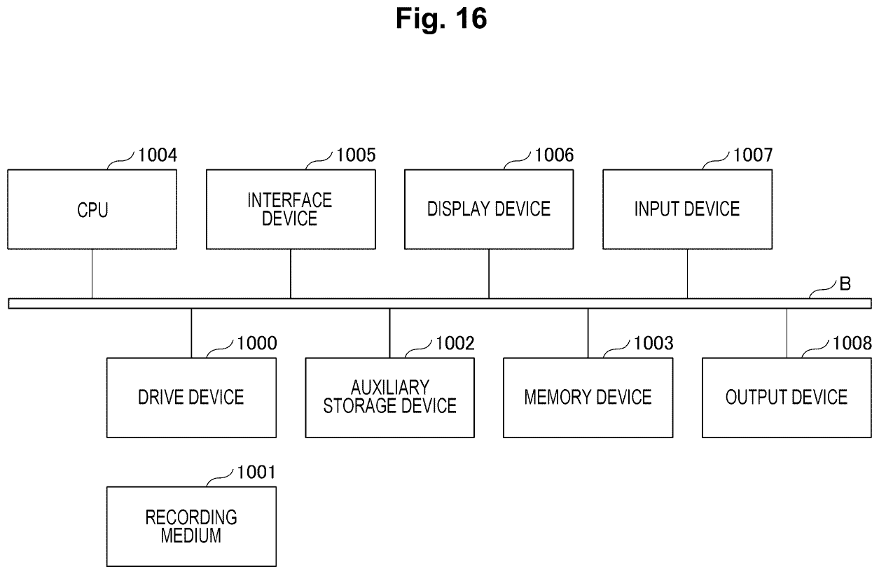

FIG. 16 is a diagram illustrating an example hardware configuration of the computer. The computer in FIG. 14 includes a drive device 1000, an auxiliary storage device 1002, a memory device 1003, a CPU 1004, an interface device 1005, a display device 1006, an input device 1007, an output device 1008, and the like, which are connected to each other by a bus B. The computer may further include a GPU.

A program for implementing processing in the computer is provided through a recording medium 1001 such as a CD-ROM or a memory card, for example. When the recording medium 1001 storing the program is set in the drive device 1000, the program is installed from the recording medium 1001 to the auxiliary storage device 1002 via the drive device 1000. However, the program is not necessarily installed from the recording medium 1001, and may be downloaded from another computer via a network. The auxiliary storage device 1002 stores the installed program, and also stores necessary files, data, and the like.

In a case where an instruction to start the program is given, the memory device 1003 reads the program from the auxiliary storage device 1002 and stores the program. The CPU 1004 implements a function related to the device in accordance with the program stored in the memory device 1003. The interface device 1005 is a functional unit for communication. The display device 1006 displays a graphical user interface (GUI) or the like according to the program. The input device 1007 includes a keyboard and a mouse, buttons, a touch panel, or the like, and is used to input various operation instructions. The output device 1008 outputs a calculation result. Note that any one or more or all of the display device 1006, the input device 1007, and the output device 1008 may not be included.

### Effects and Like of Embodiment

As described above, according to the technology described in the present embodiment, a base station device BS can predict and present, to a terminal device UE that newly makes a contract, communication quality suitable for a situation of the terminal device UE in a wireless communication system using a blockchain. Furthermore, a communication quality value in which variation in communication quality is taken into consideration can be presented to a terminal device UE.

With regard to the above embodiments, the following supplements are further disclosed.

### SUPPLEMENTS

### Supplement 1

A wireless communication system that performs connection control using a blockchain, the wireless communication system including
a base station device and a terminal device that makes a contract for connection to the base station device,
in which the base station device calculates a predicted value of communication quality providable to the terminal device on a basis of information obtained by measurement for the terminal device, and presents the predicted value to the terminal device.

### Supplement 2

The wireless communication system according to Supplement 1,
in which the base station device acquires a position of the terminal device by measurement for the terminal device, grasps another terminal device that has made a contract at a position close to the position in a past from a distributed management ledger, and calculates the predicted value on a basis of an actual value of communication quality in the base station device of the another terminal device.

### Supplement 3

The wireless communication system according to Supplement 1,
wherein the base station device acquires moving speed of the terminal device by measurement for the terminal device, grasps another terminal device that has made a contract at moving speed close to the moving speed in a past from a distributed management ledger, and calculates the predicted value on a basis of an actual value of communication quality in the base station device of the another terminal device.

### Supplement 4

The wireless communication system according to Supplement 2 or 3,
in which the base station device calculates the predicted value using an actual value of the communication quality and communication parameters of the terminal device and the another terminal device.

### Supplement 5

A base station device in a wireless communication system that performs connection control using a blockchain, the base station device including:
a quality prediction unit that, on a basis of information obtained by measurement for a terminal device that makes a contract for connection to the base station device, calculates a predicted value of communication quality providable to the terminal device; and
a transmission unit that presents the predicted value to the terminal device.

### Supplement 6

A communication quality presentation method executed by a wireless communication system that performs connection control using a blockchain,
in which the wireless communication system includes a base station device and a terminal device that makes a contract for connection to the base station device, and
the base station device calculates a predicted value of communication quality providable to the terminal device on a basis of information obtained by measurement for the terminal device, and presents the predicted value to the terminal device.

While the present embodiments have been described above, the present invention is not limited to such specific embodiments, and various modifications and changes can be made within the scope of the spirit of the present invention described in the claims.

### REFERENCE SIGNS LIST

BS Base station device
UE Terminal device
100 Wireless communication system
110 Wireless communication unit
120 Transmission unit
130 Management unit
140 Quality prediction unit
150 Conversion unit
160 Storage unit
170 Wired communication unit
210 Wireless communication unit
220 Reception unit
240 Connection control unit
250 Storage unit
1000 Drive device
1001 Recording medium
1002 Auxiliary storage device
1003 Memory device
1004 CPU
1005 Interface device
1006 Display device
1007 Input device
1008 Output device

1. A wireless communication system configured to perform connection control using a blockchain, the wireless communication system comprising:
a base station apparatus; and
a device configured to establish a contract for connection to the base station apparatus,
wherein the base station apparatus includes circuitry configured to:
calculate a predicted value of communication quality that is to be provided to the device, based on information obtained by measurement of the device, and
present the predicted value to the device.

2. The wireless communication system according to claim 1,
wherein the circuitry of the base station apparatus is configured to:
acquire a first position of the device through the measurement of the device,
grasp a second device that has established a contract at a second position close to the first position in the past from a distributed management ledger, and
calculate the predicted value based on an actual value of communication quality at the base station apparatus that is coupled to the second device.

3. The wireless communication system according to claim 1, wherein the circuitry of the base station apparatus is configured to:
acquire first moving speed of the device through measurement of the device,
grasp a second device that has established a contract at second moving speed close to the first moving speed in the past from a distributed management ledger, and
calculate the predicted value based on an actual value of communication quality at the base station apparatus that is coupled to the second device.

4. The wireless communication system according to claim 2, wherein the circuitry of the base station apparatus is configured to calculate the predicted value based on the actual value of the communication quality and communication parameters for the device and the second device.

5. A base station apparatus in a wireless communication system configured to perform connection control using a blockchain, the base station apparatus comprising:
circuitry configured to:
establish a contract for connection to the base station apparatus, based on information obtained by measurement of a device,
calculate a predicted value of communication quality that is to be provided to the device, and
present the predicted value to the device.

6. A communication quality presentation method executed by a wireless communication system that performs connection control using a blockchain, the wireless communication system including a base station apparatus and a device that establishes a contract for connection to the base station apparatus, and the communication quality presentation method comprising:
calculating, by the base station apparatus, a predicted value of communication quality that is to be provided to the device, based on information obtained by measurement of the device; and
presenting, by the base station apparatus, the predicted value to the device.
